(19) United States
(12) Patent Application Publication
(10) Pub. No.: US 2014/0157405 A1
(43) Pub. Date: Jun. 5, 2014

(54) Cyber Behavior Analysis and Detection Method, System and Architecture

(71) Applicants: Bill Joll, Irvine, CA (US); Keith Rhodes, Gross Pointe Park, MI (US); James Deerman, Lucas, TX (US)

(72) Inventors: Bill Joll, Irvine, CA (US); Keith Rhodes, Gross Pointe Park, MI (US); James Deerman, Lucas, TX (US)

(21) Appl. No.: 13/693,226

(22) Filed: Dec. 4, 2012

(51) Int. Cl. H04L 29/06

(52) U.S. Cl. CPC H04L 63/1408
USPC 726/22

(57) ABSTRACT

A scalable cyber-security system, method and architecture for the identification of malware and malicious behavior in a computer network. Host flow, host port usage, host information and network data at the application, transport and network layers are aggregated from within the network and correlated to identify a network behavior such as the presence of malicious code.

### CROSS-REFERENCE TO RELATED APPLICATIONS

This application claims the benefit of U.S. Provisional Patent Application No. 61/567,959, filed on Dec. 7, 2011, entitled “Cyber Behavior Analysis and Detection System and Architecture” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of cyber-security methods and systems.

More specifically, the invention relates to scalable cyber-security system and architecture for the identification of malware and malicious behavior in a computer network.

2. Description of the Related Art

Prior art malware security solutions deployed on computer networks from commercial providers utilize what is commonly referred to as “signature-based” (reaction-type) protection. Such solutions do not address “zero-day/zero-hour” attacks or attacks that are yet to be defined. Unfortunately, these solutions are not full-protection solutions; rather they are a reactionary solution to malware that has already been discovered or identified and are relatively easily defeated once an adversary determines the nature of the network security that is in place.

Newer malware and advanced persistent threats are not generally known on networks and may not “appear” until an intruder elects to activate them using an unauthorized command and control structure surreptitiously installed in a network, at which point valuable network data may have already been exfiltrated and traces of the intruder erased.

Prior art solutions require a network to be attacked and compromised in order for a solution to be identified, deployed and enacted.

Ideally, network security should detect the attack before the attacker is aware it has been identified.

The broad adoption of commercial and military IP-based services and applications has led to an unprecedented set of cyber-threat management problems. In order to address these problems, existing “deep packet inspection” (DPI) products have been installed in many networks. Unfortunately, these DPI products are not always capable of solving new problems or facilitating new services.

A one-problem, one-box approach to DPI has led to the deployment of armies of appliances which is not a viable long-term strategy. As a result, there is a need for the next generation of DPI products to solve a broader set of problems.

The network malware and advanced persistent threat problem can be summarized as follows:
1. DoS and DDoS (denial of service and distributed denial of service) attacks have gone mainstream: Botnet-driven DDoS attacks are likely to continue as a low-cost, high-profile form of cyber-protest into the foreseeable future.
2. Attack size and frequency accelerated: A sharp escalation in the scale and frequency of DDoS attack activity has occurred on the Internet. The largest reported attack size doubled year-over-year, to more than 100 gbps. This is an astonishing 1000% increase in attack size since the related report was published in 2005.
3. Attack surface continues to expand: As new equipment, protocols and services are introduced into networks, the attack surface for DDoS is expanded.
4. Application-layer DDoS attacks are increasing: These attacks are targeting both the ancillary support services of operators and their end customers.
5. Attacks Expose IPS and Firewall Shortcomings: These exposures result in firewall or IPS outages due to DDoS.
6. Struggling with the Transition to IPv6: Operators are concerned over the lack of visibility into IPv6 network traffic and their inability to control that traffic to the same degree they control IPv4 traffic.

According to a recent Forrester Research study and the Verizon Data Breach Investigations Report, insider threats are increasing and insiders were determined responsible for 48% of data breaches in 2009, which is up 26%. As a threat vector, 48% of data breaches were the result of privileged insiders who misuse. This is up 28% from the previous year, signifying a dramatic and worrisome trend.

According to Perimeter E-Security Research, a precipitous increase in fraud, malicious code threats, vulnerabilities, and cyber-crime is occurring. In 2008 alone, malware variants grew around 200%, while some particularly nasty bugs like data theft and Trojans have increased by more than 1,000%. What's more, today's malware is much more sophisticated and virulent than early viruses.

Major network threats include malware installed on systems when the user is lured through any number of methods to malicious or compromised websites that can exploit one of these client-side vulnerabilities. Once the malicious software is installed, it acts as a Trojan horse software program performing any number of malevolent acts including information stealing key loggers, fast flux botnets, relays, and remote control agents.

Another network threat exists in the form of malicious or careless insiders in the form of dishonest, disgruntled or negligent employees attempting to exploit the companies they currently or previously work for or that are duped or fall prey to social engineering type attacks.

Yet a further network threat exists in the form of zero-day exploits are when an attacker can compromise a system based on a known vulnerability but no patch or fix exists. Even a couple of years ago, zero-day exploits were pretty rare. They have become a very serious threat to information security. Many of these zero-day flaws reside in browsers and popular 3rd party applications. Zero day vulnerabilities are being discovered in traditionally very secure protocols such as SSL and TLS as well.

Peer-to-Peer (P2P) traffic generated by users sharing music and video files generates a large amount of traffic with random distribution patterns. Such traffic can disrupt network performance and necessitate unplanned increases in network capacity.

While most P2P traffic is generated by customers with good intentions, another class of traffic is created by hackers with the express intention of disrupting network services and performance—for example, DDOS attacks, worm propagation, VoIP service hijacking, toll fraud, credit card fraud, etc. These attacks come in multiple forms and, as defenses are created for known attacks; persistent adversaries continue to develop new attacks. DPI technology can protect a network from rogue applications such as P2P, and deliberate attacks, by monitoring, identifying, and throttling traffic at all layers of the Open Systems Interconnect (OSI) model.

A solution is a multi-purpose L2-L7 traffic management system that can mitigate current and future security threats; manage traffic from specific subscribers and applications, and craft new IP services. An advanced DPI is needed that employs comprehensive and broad-based traffic management; behavior analysis and security capabilities to solve current and future problem and that is scalable.

The difficulty with L2-L3 network technology IP networks is they are primarily built with L2-L3 switching and routing technology. The fundamental elegance of the present day layered network architecture and internet protocol (IP) suite has allowed the Internet to scale to an unimaginable size. However, the layered model can also hide the details of the higher layers of the protocol stack from the network infrastructure, effectively rendering it ‘content blind’. While this simplifies network design and implementation, it causes significant difficulties for service providers and enterprises trying to manage and control network traffic at the applications layer, e.g., L2-L3 switches and routers have extremely limited visibility into the application layer.

As an example, all web traffic is classified as a single application using TCP port 80. Given that the majority of Internet services are web-based, L2-L3 switches have virtually no visibility into the service layer. While they can determine source and destination IP addresses and TCP ports, they cannot determine the nature of the application, the user, and the content downloaded from a web site, or other aspects of the higher layer protocols and applications.

As another example, new SIP-based (session initiation protocol) services transact in L-7 and use a text-based protocol. An L2-L3 network has no SIP awareness. Therefore, an L2-L3 IP network is effectively a “dumb broadband pipe” which makes it difficult for service providers to maximize revenue with premium services or minimize negative impact on the network due to rogue applications and attacks.

Currently, a wide variety of products are used in networks to control traffic based on content. These products operate on information contained at all levels of the protocol stack with a heavy focus on the application layer. The primary current application of DPI is control of P2P traffic. As P2P has grown in popularity for MP3 and other file sharing protocols, service providers have found that network traffic was not following the traditional routes used in their network engineering plans. P2P creates a large volume of traffic requiring expensive upgrades to network infrastructure. By monitoring and throttling P2P traffic, expensive network upgrades are avoided and fair network service is provided to all subscribers.

In conjunction with P2P problems, service providers typically deploy intrusion detection and prevention systems, i.e., IDS & IPS, to mitigate the threat of various network attacks. These systems also operate at all layers of the protocol stack, but focus on detecting and preventing intrusions from hackers, worms, and viruses.

First generation DPI and IDS/IDP products focused on solving specific and important problems and have been widely deployed in networks as a result. However, the nature of application services and threats from intelligent adversaries such as in the form of Advanced Persistent Threats or ADPs which may originate from well-funded entities or nation-states, is such that the capabilities of L2-L7 content processing products must constantly change to address new needs.

The current approach to solving this problem is deploying additional L2-L7 point products into the network. Clearly, this is not an efficient long-term solution to the problem of managing changing network security requirements.

Because of the above problems and deficiencies in prior art solutions, a new generation of DPI technology is required with increased content and application processing capabilities designed to perform a wide range of functions, and execute several applications simultaneously.

By deploying an advanced DPI and threat detection across all OSI layers, such as is depicted in FIG. 1, with broad, line-speed content processing capabilities, service providers may avoid deploying multiple point products for every problem,

### BRIEF SUMMARY OF THE INVENTION

ISC8 Inc., assignee of the instant application, herein discloses a cyber-behavior analysis and detection system and method for detecting predetermined behaviors and patterns in a network which may be in the form of malware or advanced persistent threats in the network. The system of the invention is directed toward detection of cyber threats from speeds of 10 Gbps scalable to 100 Gbps or higher.

The device is scalable to meet the current and future bandwidth needs, exploiting a new system architecture that solves the line rate analysis problem.

The system comprises unique processing, memory, firmware and software elements with firmware implemented in hardware to avoid compromise by outside attackers. It provides the ability to install and execute proprietary and custom sensor algorithms without outside knowledge and provides data traffic analysis to detect, for instance, zero-day and known and previously unknown attacks and performs signature analysis to defend against previously observed attacks.

The invention therefore provides the ability to monitor all traffic in “real-time” at the network location without the need to backhaul the traffic for analysis, along with the capability to analyze all nodes at the location where the network resides for forensic analysis and pre-emption, and thus the capability to control threats by shutting them down before or during their attack.

As is generally depicted in FIG. 1, the invention comprises an IDS/IPS system that examines the threat attack from a behavior and traffic analysis perspective, triaging the threat for deep inspection as desired and is capable of analyzing L2-7 of the Open Systems Interconnection (OSI) model. The invention comprises at least the following software and related electronic elements configured to execute the software:
1. Algorithms executed in one or more network sensors for detecting malicious behavior from traffic analysis,
2. Anti-virus intrusion detection software for detecting malicious code replication such as worms and botnets,
3. Source path isolation software for tracking packets back to their origin,
4. Correlation algorithms,
5. Layer 2-7 processing software,
6. Network management software using, in one embodiment, an open source network management platform.

The above software and processing elements are preferably integrated onto a single appliance.

The invention may desirably be used for gathering, storing and correlating network statistics, network forensics and data flow identification for traffic analysis and anomaly-based intrusion detection, along with selective intercept and off-load of packets to secondary analysis systems.

The invention is preferably deployed in an inline configuration as illustrated in FIG. 1. For a gigabit Ethernet link configuration, two network interfaces are used. One interface monitors network traffic flowing from the upstream connection and one interface monitors network traffic flowing from the downstream connection. The pair of gigabit network interfaces in this embodiment provides bi-directional inspection of the traffic flowing in and out of the site being monitored across the network link.

In the system of the invention, malware alerts are delivered to a set of management network and analysis tools using, for instance, a copper 10/100/1000 Ethernet interface on an application server module. Malware alerts are preferably delivered using syslog and other common interface technologies such that, not only does the provided user interface directly integrate, but integration of other third party analysis tools will operate without changes being required.

In a first aspect of the invention, method for analyzing network, transport and application protocols in a computer network to identify a predetermined network behavior is provided comprising the steps of monitoring and logging a port usage in a first host in a computer network, monitoring and logging a set of first host information, monitoring and logging a set of data activities in the network for a predetermined change in the first host information and in a first host data flow, and generating an alert to a user based on a correlation between the logged port usage, the logged first host information and the logged first host data flow.

In a second aspect of the invention, the first host information is selected from at least one member of the group of information consisting of an IP address used by the first host, an operating system used by the first host, a service being provided by the first host, an IP protocol used by the first host, a TCP port used by the first host, a UDP port used by the first host, connected host information with which the first host communicates, services used by the first host, a TCP port contacted by the first host and a UDP port contacted by the first host.

In a third aspect of the invention, the data logged consists of data selected from at least one of the group consisting of a timestamp, an event or alert type, a rating, a network layer protocol, a transport layer protocol, an application layer protocol, a source IP address, a destination IP address, a source and destination TCP and UDP port, an ICMP type and code, a packet header field, a predetermined policy violation, a use of a predetermined application service, an IP time-to-live, a number of bytes and packets sent by a source host and a destination host for a connection, a prevention action performed, a connection or session ID, a decoded payload data, an application request and response and a state-related information set.

In a fourth aspect of the invention, a device for analyzing network, transport and application protocols in a computer network to identify a predetermined activity comprising is disclosed comprising a sensor platform comprising at least one sensor configured to collect and export a predetermined data structure comprising aggregated data about a network host, flow and address block, and comprising a sensor control processor, a correlator server configured to support at least one sensor control processor, an optical I/O module, an SRAM processing module and a DRAM processing module.

In a fifth aspect of the invention, at least one of the I/O modules, SRAM modules or DRAM modules is comprised of a combined memory array and field programmable gate array device comprising a field programmable gate array (FPGA), an access lead network electrically coupled and proximate to the FPGA, a plurality of external memories electrically coupled and proximate to the access lead network and wherein the FPGA can independently access each of the plurality of external memories via the access lead network without use of an address/data bus.

In a sixth aspect of the invention, the SRAM module comprises a plurality of interconnect ports and a plurality of independent SRAM memories and the DRAM module comprises a plurality of interconnect ports, at least one independent DRAM memory and at least one SRAM memory.

In a seventh aspect of the invention, the device further comprises a hash spectrum detector and a spectral Bloom filter.

In an eighth aspect of the invention, the device further comprises a TCP flow rectifier configured to re-order and align TCP flow content into a predetermined format.

In a ninth aspect of the invention, the predetermined format comprises TCP payload information and a header that identifies a data flow.

In a tenth aspect of the invention, the TCP flow rectifier module is configured for input header processing/flow ID extraction processing, TCP flow state and gap record management processing, buffer bypass TCP payload packet processing, DRAM buffer processing, buffer playout manager processing and output header generation processing.

In an eleventh aspect of the invention, the TCP flow rectifier is configured to output TCP payload streams in interleaved blocks for multiple flows simultaneously.

In a twelfth aspect of the invention, the TCP flow rectifier is comprised of a DRAM-based buffer memory configured for storing payload segments, and an SRAM-based flow state memory for storing a TCP flow state and a TCP gap records.

These and various additional aspects, embodiments and advantages of the present invention will become immediately apparent to those of ordinary skill in the art upon review of the Detailed Description and the claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIG. 1 depicts a block diagram of a preferred embodiment of the device and architecture of the invention.

FIG. 2 depicts a block diagram of a preferred embodiment of an optical I/O module of the invention.

FIG. 3 depicts a block diagram of a preferred embodiment of an SRAM processing module of the invention.

FIG. 4 depicts a block diagram of a preferred embodiment of a DRAM processing module of the invention.

FIG. 5 depicts a block diagram of a preferred embodiment of a configuration of the optical I/O and SRAM processing modules of FIGS. 2 and 3 in a hot-swappable, leapfrog configuration.

FIG. 6 depicts a block diagram of a preferred embodiment of the system of the invention and showing the correlation engine, sensor control processor and sensor platform.

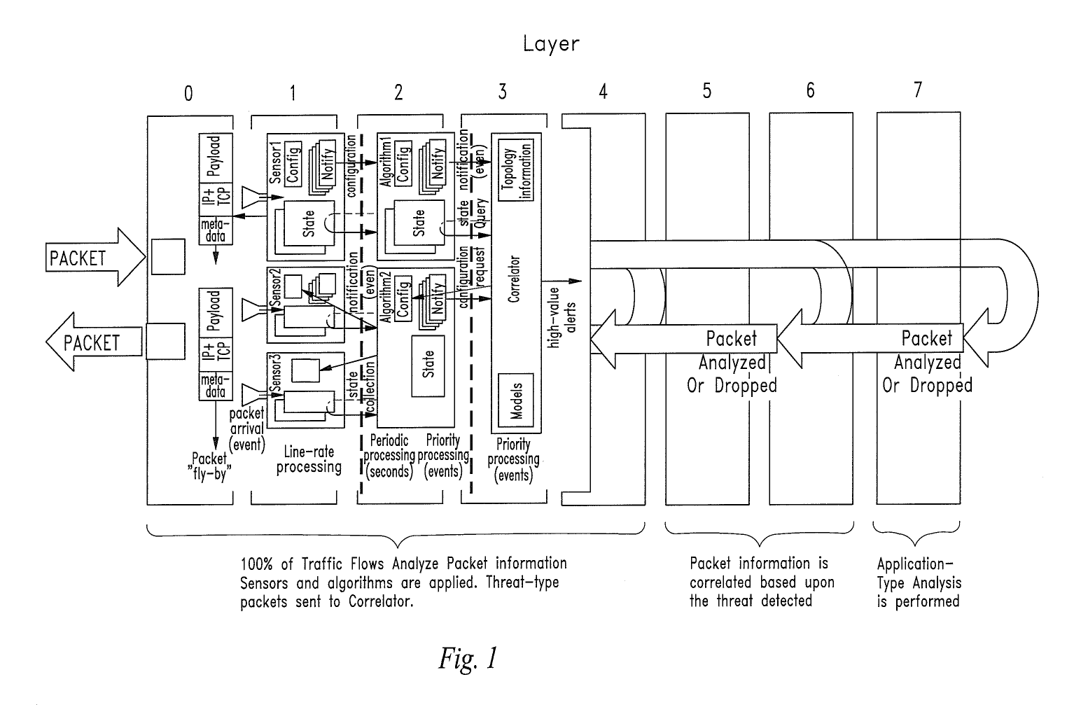

The invention and its various embodiments can now be better understood by turning to the following detailed description of the preferred embodiments which are presented as illustrated examples of the invention defined in the claims.

It is expressly understood that the invention as defined by the claims may be broader than the illustrated embodiments described below.

### DETAILED DESCRIPTION OF THE INVENTION

Traditional malware detection solutions have varying degrees of capabilities, many of which are scalable but are primarily focused on preventing and mitigating known attacks. Such scalability is achieved only through the sampling of selected information against narrow and defined threats. The invention herein is focused on the opposite end of the spectrum; analyzing all threats at wire speed from 10 Gbps and scaling to 100 Gbps and above.

The invention may generally be defined as a network-based and behavior-based intrusion monitoring and detection system for predetermined network segments or devices connected to the network inside the network's firewall that analyzes network, transport, and application protocols therein to identify suspicious activity.

A discussion of network-based and behavior-based Intrusion Detection and Prevention System (IDPS) technologies follows and includes a brief overview of TCP/IP, which is general background material for understanding. The following discussion further provides background on the security capabilities, including the methodologies, used to identify suspicious activity,

TCP/IP is well-known and widely used throughout the world to provide network communications. TCP/IP communications are composed of four “layers” that work together. When a user wishes to transfer data across networks, the data is passed from the highest layer through intermediate layers to the lowest layer, with each layer adding more information to the data.

The lowest layer sends the accumulated data through the physical network and the data is then passed up through the layers to its ultimate destination. Essentially, the data produced by a layer is encapsulated in a larger container by the layer below it. The four TCP/IP layers, from highest to lowest, are discussed below.

Application Layer: This layer sends and receives data for particular, predetermined applications. The application layer enables applications to transfer data between an application server and client. An example of an application layer protocol is Hypertext Transfer Protocol (HTTP), which transfers data between a Web server and a Web browser. Other common application layer protocols include Domain Name System (DNS), File Transfer Protocol (FTP), Simple Mail Transfer Protocol (SMTP), and Simple Network Management Protocol (SNMP). There are hundreds of unique application layer protocols in common use, and many more that are not so common. Regardless of the protocol in use, application data is generated and then passed to the transport layer for further processing.

Transport Layer: This layer provides connection-oriented or connectionless services for transporting application layer services between networks. The transport layer can optionally ensure the reliability of communications. Transmission Control Protocol (TCP) and User Datagram Protocol (UDP) are commonly used transport layer protocols.

The transport layer is responsible for packaging data so that it can be transmitted between hosts. Most applications that communicate over networks rely on the transport layer to ensure reliable delivery of data. Generally, this is accomplished by using TCP. When the loss of some application data is not a concern (e.g., streaming audio, video), or the application itself ensures reliable delivery of data, UDP is typically used. UDP is connectionless; one host simply sends data to another host without any preliminary negotiations. Each TCP or UDP packet has a source port number and a destination port number. One of the ports is associated with a server application on one system; the other port is associated with a corresponding client application on the other system. Client systems typically select any available port number for application use, whereas server systems usually have a static port number dedicated to each application. Although UDP and TCP ports are very similar, they are distinct from each other and are not interchangeable.

Internet Protocol (IP) Layer (also known as Network Layer): This layer routes packets across networks. IPv4 is the fundamental network layer protocol for TCP/IP. Other commonly used protocols at the network layer are IPv6, Internet Control Message Protocol (ICMP), and Internet Group Management Protocol (IGMP).

The network layer, also known as the IP layer, is responsible for handling the addressing and routing of data that it receives from the transport layer. After the network layer has encapsulated the transport layer data, the resulting logical units are referred to as packets. Each packet contains a header, which is composed of various fields that specify characteristics of the transport protocol in use; optionally, packets may also contain a payload, which holds the application data. The IP header contains a field called IP Version, which indicates which version of IP is in use. Typically this is set to “4” for IPv4; but the use of IPv6 is increasing, so this field may be set to “6” instead.

Other significant IP header fields are:

Source and Destination IP Addresses. These are the “from” and “to” addresses that are intended to indicate the endpoints of the IP communication. Examples of IP addresses are 10.3.1.70 (IPv4) and 1000::2F:8A:400:427:9 BD1 (IPv6).

IP Protocol Number. This indicates which network or transport layer protocol the IP contains. Commonly used IP numbers include 1(ICMP), 6(TCP), 17(UDP), and 50(Encapsulating Security Payload [ESP]).

The network layer is also responsible for providing error and status information involving the addressing and routing of data; it does this with ICMP.

ICMP is a connectionless protocol that makes no attempts to guarantee that its error and status messages are delivered. Because it is designed to transfer limited information, not application data, ICMP does not have ports; instead, it has message types, which indicate the purpose of each ICMP message. Some message types also have message codes, which can be thought of as subtypes. For example, the ICMP message type Destination Unreachable has several possible message codes that indicate what is unreachable (e.g., network, host, protocol). Most ICMP message types are not intended to elicit a response.

Hardware Layer (also known as Data Link Layer): This layer handles communications on the physical network components. The best known data link layer protocol is Ethernet. As the name implies, the hardware layer, also called the data link layer, involves the physical components of the network, including cables, routers, switches, and network interface cards (NIC). The hardware layer also includes various hardware layer protocols, with Ethernet being the most widely used.

Ethernet relies on the concept of a media access control (MAC) address, which is a unique six-byte value (such as 00-02-B4-DA-92-2C) that is permanently assigned to a particular NIC. Each frame, the logical unit at the hardware layer, contains two MAC addresses, which indicate the MAC address of the NIC that just routed the frame and the MAC address of the next NIC to which the frame is being sent. As a frame passes through networking equipment (such as routers and firewalls) on its way between the original source host and the final destination host, the MAC addresses are updated to refer to the local source and destination. Several separate hardware layer transmissions may be linked together within a single network layer transmission.

In addition to the MAC addresses, each frame also contains an EtherType value, which indicates the protocol that the frame's payload contains (typically IP or Address Resolution Protocol [ARP]). When IP is used, each PP address maps to a particular MAC address. (Because multiple IP addresses can map to a single MAC address, a MAC address does not necessarily uniquely identify an IP address.)

The above four TCP/IP layers cooperate to transfer data between hosts. Network-based intrusion detection and prevention devices (IDPS) typically perform most of their analysis only at the application layer. They may also analyze activity at the transport and network layers, both to identify attacks at those layers and to facilitate the analysis of application layer activity (e.g., a TCP port number may indicate which application is being used). Some network-based IDPSs perform limited analysis at the hardware layer.

The invention herein is a Network Behavior Analysis (NBA) solution comprised of appliances and consoles and offering management servers (which are sometimes called analyzers). The system is similar to network-based IDPS appliances in that it sniffs packets to monitor network activity on one or a few network segments. Other NBA appliances do not monitor the networks directly, but instead rely on network flow information provided by routers and other networking devices.

The term “flow” as used herein refers to a particular communication session occurring between hosts. There are many standards for flow data formats, including NetFlow and sFlow.

Typical flow data particularly relevant to intrusion detection and prevention includes the following:
1. Source and destination IP addresses,
2. Source and destination TCP or UDP ports or ICMP types and codes,
3. Number of packets and number of bytes transmitted in the session,
4. Timestamps for the start and end of the session.

Threat sensors of the invention perform network behavior analysis (NBA) by examining network traffic or statistics on network traffic to identify unusual traffic flows, such as distributed denial of service (DDoS) attacks, certain forms of malware (e.g., worms, backdoors), and policy violations (e.g., a client system providing network services to other systems).

The sections below describe common security capabilities of the system of the invention and are divided into four categories: information gathering, logging, detection, and prevention, respectively. Certain embodiments may be configured to provide security information and event management (SIEM) capabilities.

The system of the invention provides information gathering capabilities, because knowledge of the characteristics of the organization's hosts is used for detection techniques. The invention automatically creates and maintains lists of hosts communicating on the organization's monitored networks. The invention is configured to monitor port usage, perform passive fingerprinting, and use other techniques to gather detailed information about the hosts on the network (there is also a requirement to allow administrators to specify detailed firewall rule set-like policies for host-to-host communications, including permitted or forbidden port numbers.) Host information collected by the system may include the following:
1. IP address,
2. Operating system,
3. What services the host is providing, including the IP protocols and TCP and UDP ports it uses to do so,
4. Other hosts with which a host communicates, and what services it uses and which IP protocols and TCP or UDP ports it contacts on each host.

The invention constantly monitors network activity for changes to the host information. Additional information on each host's flows is also collected on an ongoing basis.

The invention is configured to perform extensive logging of data related to detected network and host events. This data can be used to confirm the validity of alerts, to investigate incidents, and to correlate events between the invention and other logging sources. Data fields commonly logged by the invention may include the following:
1. Timestamp (usually date and time,
2. Event or alert type,
3. Rating (e.g., priority, severity, impact, confidence),
4. Network, transport, and application layer protocols,
5. Source and destination IP addresses,
6. Source and destination TCP or UDP ports, or ICMP types and codes,
7. Additional packet header fields (e.g., IP time-to-live [TTL]),
8. Number of bytes and packets sent by the source and destination hosts for the connection,
9. Prevention action performed (if any),
10. Connection or session ID (typically a consecutive or unique number assigned to each TCP connection or to like groups of packets for connectionless protocols),
11. Decoded payload data, such as application requests and responses,
12. State-related information (e.g., authenticated username).

A preferred embodiment of the invention is configured to directly monitor network traffic are also able to log limited payload information from packets, such as authenticated user identifiers. This allows actions to be traced to specific user accounts. The invention can also be provided to perform packet captures. Typically this is done once an alert has occurred, either to record subsequent activity in the connection or to record the entire connection if the invention has been temporarily storing the previous packets.

The invention is provided with the capability to detect several types of malicious activity and is used for anomaly-based detection, along with some stateful protocol analysis techniques, to analyze network flows. This section discusses the following aspects of the software detection capabilities the invention is configured to execute:
1. Types of events detected,
2. Detection accuracy,
3. Tuning and customization,
4. Technology limitations.

The types of events most that may be detected by the invention may include the following:

Denial of service (DoS) attacks (including distributed denial of service [DDoS] attacks). These attacks typically involve significantly increased bandwidth usage or a much larger number of packets or connections to or from a particular host than usual. By monitoring these characteristics, anomaly detection methods can determine if the observed activity is significantly different than the expected activity. The invention is configured to be aware of the characteristics of common DoS tools and methods, which can help them to recognize the threats more quickly and prioritize them more accurately.

Scanning can be detected by a typical flow patterns at the application layer (e.g., banner grabbing), transport layer (e.g., TCP and UDP port scanning), and network layer (e.g., ICMP scanning).

Worms spreading among hosts can be detected in more than one way. Some worms propagate quickly and use large amounts of bandwidth. Worms can also be detected because they can cause hosts to communicate with each other that typically do not, and they can also cause hosts to use ports that they normally do not use. Many worms also perform scanning; this can be detected as previously explained.

Unexpected application services (e.g., tunneled protocols, backdoors, use of forbidden application protocols). These are usually detected through stateful protocol analysis methods, which can determine if the activity within a connection is consistent with the expected application protocol.

The invention is configured to allow administrators to specify detailed policies, such as which hosts or groups of hosts a particular system may or may not contact, and what types of activity are permissible only during certain hours or days of the week. Most sensors also detect many possible policy violations automatically, such as detecting new hosts or new services running on hosts, which could be unauthorized.

The invention is configured to create a list of hosts on the organization's network arranged by IP address or MAC address. The list can be used as a profile to identify new hosts on the network.

The invention is configured to identify the OSs and OS versions used by the organization's hosts through various techniques. For example, the sensor of the invention tracks which ports are used on each host, which indicates a particular OS or OS family (e.g., Windows, Unix). Another technique is to analyze packet headers for certain unusual characteristics or combinations of characteristics that are exhibited by particular OSs; this is known as passive fingerprinting. The sensors identify application versions (as described below), which in some cases implies which OS is in use. Knowing which OS versions are in use is helpful in identifying potentially vulnerable hosts.

For some applications, the invention may be configured to identify the application versions in use by keeping track of which ports are used and monitoring certain characteristics of application communications. For example, when a client establishes a connection with a server, the server tells the client what application server software version it is running, and vice versa. Information on application versions are used to identify potentially vulnerable applications, as well as unauthorized use of some applications.

The invention collects general information about network traffic related to the configuration of network devices and hosts, such as the number of hops between two devices. This information is used to detect changes to the network configuration.

The invention is configured to reconstruct a series of observed events to determine the origin of a threat. For example, if worms infect a network, system sensors analyze the worm's flows and find the host on the organization's network that first transmitted the worm to other hosts.

Application layer reconnaissance and attacks (e.g., banner grabbing, buffer overflows, format string attacks, password guessing, malware transmission). The invention analyzes several dozen application protocols. Commonly analyzed protocols include Dynamic Host Configuration Protocol (DHCP), DNS, Finger, FTP, HTTP, Internet Message Access Protocol (IMAP), Internet Relay Chat (IRC), Network File System (NFS), Post Office Protocol (POP), rlogin/rsh, Remote Procedure Call (RPC), Session Initiation Protocol (SIP), Server Message Block (SMB), SMTP, SNMP, Telnet, and Trivial File Transfer Protocol (TFTP), as well as database protocols, instant messaging applications, and peer-to-peer file sharing software.

Transport layer reconnaissance and attacks (e.g., port scanning, unusual packet fragmentation, SYN floods). The most frequently analyzed transport layer protocols are TCP and UDP.

Network layer reconnaissance and attacks (e.g., spoofed IP addresses, illegal IP header values). The most frequently analyzed network layer protocols are IPv4, ICMP, and IGMP with support for IPv6 analysis. CBADS performs full analysis of the IPv6 protocol, such as confirming the validity of IPv6 options, to identify anomalous use of the protocol.

Unexpected application services (e.g., tunneled protocols, backdoors, hosts running unauthorized application services). These are detected through stateful protocol analysis methods in the invention, which can determine if the activity in a connection is consistent with the expected application protocol, or through anomaly detection methods, which can identify changes in network flows and open ports on hosts.

Policy violations (e.g., use of inappropriate Web sites, use of forbidden application protocols). Some types of security policy violations are detected by the invention that allow administrators to specify the characteristics of activity that should not be permitted, such as TCP or UDP port numbers, IP addresses, Web site names, and other pieces of data that can be identified by examining network traffic.

The invention monitors the initial negotiation conducted when establishing encrypted communications to identify client or server software that has known vulnerabilities or is misconfigured. This includes application layer protocols such as secure shell (SSH) and Secure Sockets Layer (SSL), and network layer virtual private networking protocols such as IP Security (IPsec).

The sensors of the invention are configured to determine if an attack is likely to succeed. For example, sensors might know which Web server software versions are running on each of the organization's Web servers. If an attacker launches an attack against a Web server that is not vulnerable to the attack, then the sensor might produce a low-priority alert; if the server is thought to be vulnerable, then the sensor might produce a high-priority alert. The invention is typically configured to stop attacks whether or not they are likely to succeed, but may log the activity with different priority levels depending on what its outcome probably would have been if not blocked.

The invention works primarily by detecting deviations from normal behavior, and is particularly accurate at detecting attacks that generate large amounts of network activity in a short period of time (e.g., DDoS attacks) and attacks that have unusual flow patterns (e.g., worms spreading among hosts).

Detection accuracy also varies over time. Because the invention uses primarily anomaly-based detection methods, it is best suited to detect attacks that reach a point where their activity is significantly different from what is expected in the monitored network. If a DoS attack starts slowly and increases in volume over time, it is more readily detected by the invention. By configuring the sensors of the invention to be more sensitive to anomalous activity, alerts are generated more quickly when attacks occur, but more false positives are also likely to be triggered.

Conversely, if sensors are configured to be less sensitive to anomalous activity, there will be fewer false positives, but alerts will be generated more slowly, allowing attacks to occur for longer periods of time.

False positives can also be caused by benign changes in the environment. For example, if a new service is added to a host and a few hosts start using it, the appliance may detect this as anomalous. However, typically this would be a low-priority alert, and not reported as an attack, so this can truly be considered a false positive. If a major service is moved from one host to another and a thousand hosts start using it one day, which might inadvertently trigger an alert.

As indicated earlier, the invention relies primarily on observing network traffic and developing baselines of expected flows and inventories of host characteristics. Desirably, the invention is configured to automatically update its baselines on an ongoing basis. As a result, there is not significant tuning or customization to be performed, other than updating firewall rule set-like policies that are offered by most products. Also, administrators may wish to adjust thresholds periodically (e.g., how much additional bandwidth usage should trigger an alert) to take into account changes to the environment. Thresholds can often be set on a per-host basis or for administrator-defined groups of hosts. The invention offers whitelist and blacklist capabilities for hosts and service and is customizable for each alert (e.g., specifying which prevention option it should trigger).

The appliance is preferably configured with signature-based detection capabilities. The supported signatures primarily look for particular values in certain IP, TCP, UDP, or ICMP header fields. This capability is most helpful for inline deployment mode because signatures can be used to find and block attacks that a firewall or router might not be capable of blocking. For example, suppose that there is a DDoS attack that uses a flood of specially-crafted HTTP traffic against a Web server. A firewall or router might not be able to block the attack without blocking all HTTP activity to the Web server, but the inline appliance may be configured with a customized signature to block just the attack activity if it has a unique set of characteristics and is able to block the attack because of its flow patterns.

Besides reviewing tuning and customizations periodically to ensure that they are still accurate, administrators should also ensure that significant changes to hosts, such as new hosts and new services, are reflected in the device settings.

The sensors of the invention are reconfigurable to offer various intrusion prevention capabilities, which may include the following:

Performing Inline Firewalling. Firewall capabilities that can be used to drop or reject suspicious network activity.

Reconfiguring Other Network Security Devices. Ability to instruct network security devices such as firewalls and routers to reconfigure themselves to block certain types of activity or route it elsewhere, such as a quarantine virtual local area network (VLAN).

Running a Third-Party Program or Script. Ability to run an administrator-specified script or program when certain malicious activity is detected

Performing Inline Firewalling. Most inline IDPS sensors offer firewall capabilities that can be used to drop or reject suspicious network activity.

Throttling Bandwidth Usage. If a particular protocol is being used inappropriately, such as for a DoS attack, malware distribution, or peer-to-peer file sharing, the invention is provided limits the percentage of network bandwidth that the protocol can use. This prevents the activity from negatively impacting bandwidth usage for other resources.

Altering Malicious Content. The device is configurable to sanitize part of a packet, which means that malicious content can replaced with benign content and the sanitized packet sent to its destination. An appliance that acts as a proxy might perform automatic normalization of all traffic, such as repackaging application payloads in new packets. This has the effect of sanitizing some attacks involving packet headers and some application headers, whether or not the device has detected an attack. Some sensors can also strip infected attachments from e-mails and remove other discrete pieces of malicious content from network traffic.

The device of the invention allows administrators to specify the prevention capability configuration for each type of alert. This includes enabling or disabling prevention, as well as specifying which type of prevention capability should be used. The system implementations use prevention capabilities in a limited fashion or not at all because of false positives; blocking a single false positive could cause major disruptions in network communications. Prevention capabilities are most often used for NBA sensors when blocking a specific known threat, such as a new worm.

Detection accuracy is likely to be decreased during implementation and initial usage because the appliances will have substantially incomplete information about their environment until they have monitored it for days or weeks.

The invention is designed to be operated and maintained through consoles that offer visualization tools that can display the flow of attacks through an organization's networks. These tools can show a user which hosts were affected by an attack, the sequence of hosts that an attack passed through, and the first host to be involved in the attack.

The system examines network traffic or statistics on network traffic to identify unusual traffic flows using sensors and consoles. Some sensors are similar to network-based IDPS sensors in that they sniff packets to monitor network activity on one or a few network segments. Other sensors do not monitor the networks directly, but instead rely on network flow information provided by routers and other networking devices.

Inline sensors are best suited for network perimeter use, so are deployed in close proximity to the perimeter firewalls, often in front to limit incoming attacks that could overwhelm the firewalls.

The hardware of the invention is comprised of a line-rate, pipelined architecture with complete packets flowing through self-contained sensor modules; modules operate at full line rate (10 Gbps scalable to 100 Gbps) and with fixed delay and memory usage.

Sensor modules collect specialized data structures which are exported to a software layer in a conventional CPU at much lower data rates (<1 Gb/s); this data is organized into arrays of data structures that are much more efficient for a conventional CPU to process than raw packets—data about the same entity (host, flow, address block, etc.) is aggregated into a single record, rather than spread over many, widely-separated packets. The processed sensor data can generate various indications of “interesting” data, depending on the sensor. Hardware sensors can also produce immediate indications of interesting data, but require careful design and throttling controls to avoid overtaxing the software-level CPU's capabilities.

For the most part, firewalls are present in adequate forms in enterprise router gear, and going beyond what the routers can do typically is the realm of so-called Intrusion-Prevention Systems. The hardware architecture of the invention readily supports selective dropping of packets in a pass-through installation model (as opposed to a port-mirrored installation model), but most of the truly valuable (and reliable) detection occurs at latencies or using methods that are inconsistent with blocking malware packets at line-rate timeframes.

If there are line-rate sensors that are sufficiently definitive, e.g. malware string matching, then filtering functionality can be added based on these sensor results being included in the packet metadata carried down the processing pipeline.

Typically based on regexp-matching technology, traffic signature matching is hard to scale to high speeds due to arbitrary number of memory references for sequential-byte signature detection with large numbers of patterns. It also generally requires TCP reassembly so signatures crossing packet boundaries are properly detected. There are specific subcases of signature matching that are traceable and relatively easily implemented (e.g. CALEA-style lawful intercept).

The hardware can be used as a traffic splitter (by re-writing IP and/or Ethernet destination addresses on packets flowing through), providing a highly programmable front end for a more classical cluster processing system (which will be prone to the usual per-processor throughput issues with traffic transients dropping packets).

The hardware of the invention supports many classical “bump-in-the-wire” functions, such as firewall filtering, IPsec gateway, traffic prioritization, etc.

The general system architecture is a sensor platform (hardware platform) comprising sensors (firmware and firmware infrastructure) and a sensor control processor, a correlator server which may support multiple sensor control processors and may be combined with sensor control function in small-scale deployment, an operator workstation that may support multiple correlators and cloud services that may supply inter-enterprise data correlation, may supply config data for some sensors and supports user-tailored sensor firmware downloads.

Components of the system are a high-value target for malware users and information thieves (a compromised sensor can eavesdrop on all passing traffic, for example), so system-wide security is crucial this should include limiting all sensor→control CPU and control-CPU→operator station traffic to whitelisted nodes with verifiable identities (e.g. require IPsec use or equivalent on all network communications).

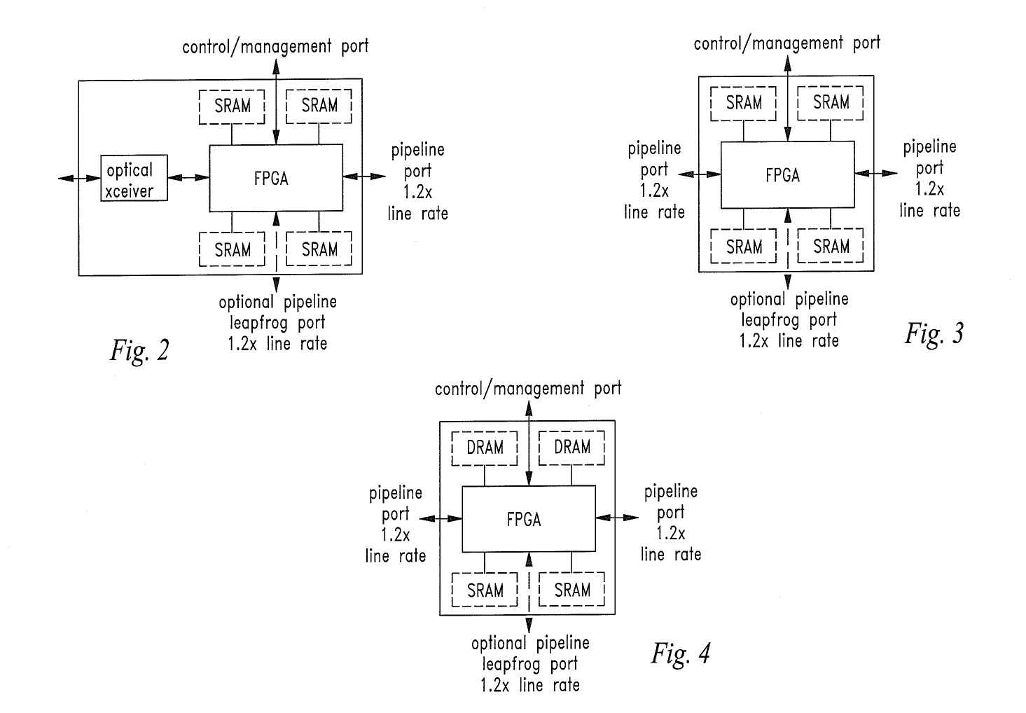

A preferred embodiment of an optical I/O module for use in the system of the invention is depicted in FIG. 2. The optical I/O module may comprise one optical I/O port, with two interconnect ports, and be provided with optional 2-4 SRAM ports.

A preferred embodiment of an SRAM processing module for use in the system of the invention is depicted in FIG. 3. The SRAM processing module may comprise two or three interconnect ports and four independent SRAM memories. The SRAM memory ports may be 36 bits wide. The SRAM may be DDR for operations at 200 MHz for 10 G, 200 MHz QDR for operations at 40 G and 250+ MHz QDR for operations at 100 G.

SRAM memory size may vary based on application, but 1Mx144 for 10 G is acceptable for 4Mx72 for operations at 100 G. Different sensors have different requirements for memory depth; some depend on number of flows seen over collection interval, some depend on number of protected hosts, some on number of routable external address blocks.

A TCP flow rectifier is provided and is a firmware block that fits into the cyber firmware pipeline, and re-orders and aligns TCP flow content into a special output format that can be processed by downstream sensors which wish to perform content inspection without worrying about out-of-order or overlapping data segments (which is sometimes used by malware authors to confuse IDSes).

Data output from the TCP flow rectifier is still in a pseudo-packet format, but contains only the TCP payload information plus a special header that identifies the flow (actual IP address and port information about the flow is obtained from a TCP flow sensor upstream in the pipeline, if needed, using the internal flow ID. Sensors downstream from the flow deal with boundaries in the pseudo-packets of a given flow, but can simply save and restore state for that flow at packet boundaries. Gaps in the content are indicated in the pseudo-packet header.

The basic structure of the TCP flow rectifier module may comprise the following sub-blocks:

Input header processing/flow ID extraction

TCP flow state and gap record management

Buffer bypass for “current” TCP payload packets

DRAM buffer for in-future segments (post-gap payload)

Buffer playout manager

Output header generation (for TCP segment packets)

The TCP flow rectifier is best understood as an “on the fly” TCP payload reassembly processor which outputs TCP payload streams in interleaved blocks for multiple flows simultaneously. This contrasts with the classical TCP re-assembly in a host, where each flow is re-assembled into its own memory structure before being passed to application-level processing. However, the output data for any given flow looks very similar to what flows to an application-level TCP socket in a classical operating system. (i.e., the TCP flow rectifier acts much like a “TCP offload” network interface card in many ways.).

In a preferred embodiment, the TCP flow rectifier preferably operates at line rate (10 or 100 Gb/s), places all TCP payload data into the correct order for downstream sensors, deals with overlapping TCP segments (duplicated payload bytes) by sending on only one copy and works with short TCP packets as well as long (MTU-sized) ones.

In addition, the TCP flow rectifier may detect when overlapping TCP data segments are inconsistent, which is a strong indicator of malicious behavior.

In an exemplar embodiment, a 10 G TCP flow rectifier comprises 1 G×32 400 MHz DDR DRAM (800 Mb/s per I/O pin) plus 1M×144 DDR or QDR SRAM running at 200 MHz DDR; an FPGA daughter-card with two 1 G×32 400 MHz DDR DRAM ports and two 1M×144 200 MHz DDR SRAM ports.

In an alternative exemplar embodiment, a 100 G TCP flow rectifier may comprise 1 G×256 DDR DRAM operating at least 400 MHz clock, but preferably 500 MHz, plus two 1M×72 250 MHz QDR SRAM ports; two FPGAs to get a sufficient number of I/O.

Note that in both 10 G and 100 G, a fairly long read/write bursts to sequential DRAM addresses is expected, so bus turn-around is not limiting. (This is predicated on typically-MTU-sized packets being stored, so access latency isn't a problem.)

The TCP flow rectifier has two primary data structures: a DRAM-based buffer memory for holding “future” (post-gap) payload segments, and an SRAM-based flow state memory which contains the TCP flow state and some number of TCP gap records.

In the DRAM buffer, it is preferable to break the DRAM into two regions; one for small-window TCP sessions, and one for large-window sessions.

The small-window session buffers are 64 Kbytes each, with data being stored into them based directly on the low bits of the sequence number for the start of the incoming segment. The size of large-window TCP buffers is user-defined.

In both regions, a single contiguous block of memory is assigned to a single flow.

In one embodiment, the DRAM is split into two equal regions, since that makes the indexing simple.

The TCP flow record contains both the TCP session information and some number of gap records, describing regions of the session sequence number space that have no stored data in the DRAM Buffer. There will generally be one gap in an active TCP flow, representing unseen payload data after the last payload byte seen so far.

TCP flow record memory layout:

[1] active/empty flag

[4] extra hash bits for flowID hash disambiguation

[1] large window flag

N×gap records (sorted in increasing start seq# order)

[1] “used/empty” flag

[1] “last gap” flag

[32] gap-start sequence#

[32] gap-end sequence#

With a natural 144-bit SRAM memory operation width, the basic memory entry can contain two gap records (132 bits total) and up to 12 bits of TCP flow state. Extra bits may be used to extend the hash disambiguation value. Note that, at least for small-window TCP sessions, the gap-end sequence number can also be stored as a 16-bit offset from the gap-start—this is acceptable due to the 16-bit limit on the outstanding window size; anything beyond the window is illegal, and a reportable anomaly, and does not need to be stored.

With 144-bit memory words, there is no real benefit to compressing the end sequence number, since three 50-bit gap records would not fit into a single 144-bit word. However, the gap records can be compressed further by observing that the start of the last gap can be no greater than the start of the first gap, plus the window size. Thus, only the first gap record requires 32 bits of starting sequence number, and all the remaining start and end sequence numbers can be 16 bit offsets (for regular TCP window flows).

With this variant, three 34-bit gap records could be stored in the 144-bit memory word, along with the 6 TCP flow state bits, and the upper 16 bits of the first gap starting sequence number. For large-window flows, some compression is possible, but depends on what maximum TCP window sizes are actually used for large-window flows. It is preferable to use the simple, two-gap version of the memory record, with full sequence numbers. If a significant fraction of TCP flows see three or more outstanding gaps, then one of the compression or spillover schemes may be employed. Which scheme to choose is dictated by the histogram of outstanding gaps per flow over a large number of simultaneous flows. If only a small number of flows have many gaps, a spillover table scheme using Virtex-6 BlockRAM may be used.

With respect to the output data format of the TCP flow rectifier, below is a representative set of values of a TCP payload segment pseudo-packet header:

[32] flowID (hash table index value)

[2] flow start/end flags

[16] payload segment length

[32] preceding gap size (usually 0)

[16] urgent pointer

other meta-data payload

A preferred DRAM processing module of FIG. 4 may comprise two-three interconnect ports, one or two independent DRAM memories, two SRAM memories and is used for TCP flow rectifier applications, and for data capture/lawful intercept configurations.

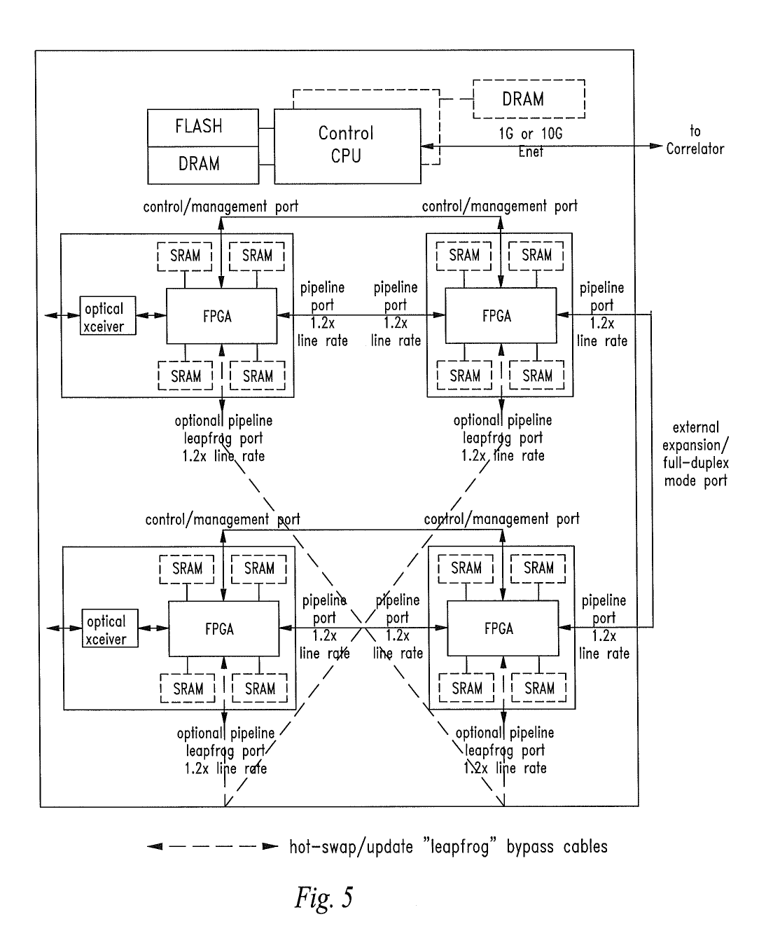

FIG. 5 depicts a preferred module interconnect option comprising two or three line-rate full-duplex interconnects per module. The use of three modules supports “leapfrog bypass” hot swap and N+1 redundancy (for lossless hot firmware updates). The illustrated motherboard can be daisy-chained to others via an expansion interconnect port but requires the use of there-port FPGA modules. The board controller is preferably a high-end CPU with 4-8 GB DRAM with disk drive for archiving, including sensor algorithm processing; and in lower-demand applications, may be configured to run the correlator. The module may comprise multiple CPUs (or expansion sockets for them) to support local correlator or layer-7 processing functions. The use of additional CPUs should include dedicated DRAM, rather than sharing with first CPU (i.e. not a multi-core scheme), since DRAM access dominates performance of the motherboard CPU applications. In an alternative embodiment, a low-end embedded CPU may be proved which simply pushes data out to sensor algorithm processor and correlator in separate modules.

In the single-board case embodiment, the control plane is most easily be implemented as PCI Express, though this requires either a PCI-Express to local-bus bridge on the carrier board to provide the control plane connection to the daughter-cards, or the daughter-cards should include a PCI-Express bridge of some sort—trying PCIExpress directly to the pipeline processing FPGA on the daughter-card may present a number of practical issues—in particular, it may use up high-speed serial interface blocks needed for the main data path, and preferably isn't used to load the FPGA code.

The control processor comprises a sensor software layer, correlator, data archiver, and UI using conventional Linux or BSD Unix CPU. The sensor processor and correlator are preferably separate CPUs in high-end configurations.

A preferred embodiment of the single-board embodiment of the invention may comprise one or a plurality of memory-enhanced field programmable gate arrays as is disclosed in U.S. Pat. No. 6,856,167 entitled “Field Programmable Gate Array with a Variably Wide Word Width Memory” issued Feb. 15, 2005 where all memory bits are simultaneously available to the FPGA such that the FPGA, incorporating suitable logic, can implement a virtual word width of any desired width from 1 to mXN bits.

The plurality of FPGA modules in this embodiment are each coupled to an access lead network formed by a proximate interposer board and coupled to a plurality of memories which may be SRAM of DRAM memory elements.

This section describes the firmware and software architecture comprising the hardware sensor layer VHDL, pipeline model, flow-through packet format, metadata, and related processing elements.

The sensors and sensor algorithm modules comprise firmware sensor control, configuration, data recording, formatting, cross-time-slice data analysis within sensor. A Layer 7 selector is provided acting as a traffic tap which selects a subset of line-rate packets for full layer-7 stream reconstruction (TCP reassembly) and content-aware analysis. The choice of packets to be tapped is dynamic, driven by correlator interest in particular internal or external hosts, or individual traffic flows, where Layer-7 sensors might confirm or refute suspected malicious behavior. For example: in the event an internal host suddenly starts HTTP sessions with a number of external peers never before referenced by the internal network; inspection of the traffic might confirm exfiltration or botnet command/control activities.

For a control-plane version of selector, selected traffic rate should be limited to somewhere between 100 Mb/s and 1 Gb/s, depending on loading of layer-7 processing CPU; if the control plane connection from the sensor layer is 10 Gb/s, then up to 3 Gb/s of traffic is diverted up to the control processors, but use L7 processing CPUs and traffic splitting between them.

A selector can also use the line-rate data path output interface to operate as a traffic splitter to a conventional CPU cluster connected to a high-speed switch; this may be done by adding a new Ethernet header at the pipeline output based on metadata indicating which L7 CPU should get the packet for analysis. The Layer-7 selector supports CALEA-style legal intercept, including on selection by content-based user-IDs, email addresses, etc.

The selector may be configured by data from the L7 analysis CPU, correlator needs for additional data, or even meta-data added by upstream sensors in the pipeline (e.g. the packet is known to be to/from a never-seen-before external host, or contains suspect features like IP fragments or odd port combinations).

As earlier indicated, the sensor algorithm modules comprise firmware sensor control/configuration/data recording/formatting, cross-time-slice data analysis within the sensor. A sensor archiver is provided for forensic analysis, possible input to correlator for historical data supporting hypotheses.

Layer 7 processing is performed using conventional software-based Layer-7 packet/data stream processing, such as is available from Qosmos, to extract features from data traffic content.

A correlator engine performs cross-sensor data integration and reasoning, normal/error/malware traffic models and hypotheses

A status user interface (UI) provides real-time status displays to network/enterprise operator: alerts are sorted by priority/confidence, possibly “heat maps” or other displays of host activity, world heat-map of external peer activity and may include some global actions for the operator (e.g. “turtle up” against an obvious attack), or enable/disable levels of external access.

The forensic UI is configured to dig down into specific alerts; may include specific actions related to internal or external hosts, such as disabling/limiting network access, or blocking external access from certain addresses or address blocks.

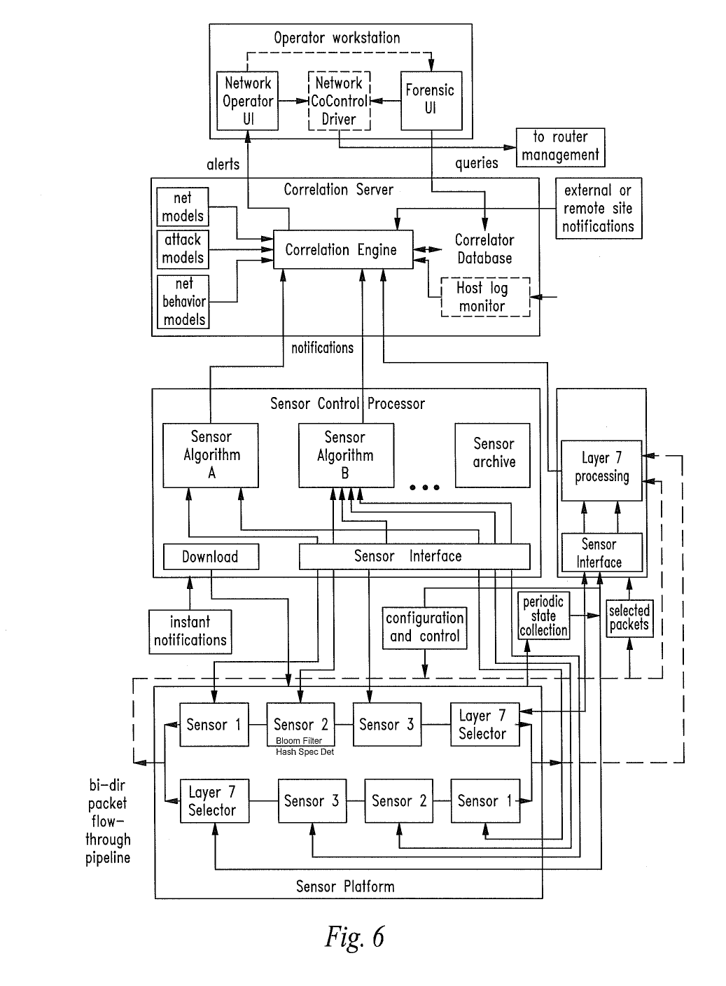

Hardware management (“Download” in FIG. 6) is used to perform firmware updates and downloads to hardware, validation and version control, and updates from service providers.

Software is preferably configured to facilitate multi-node enterprises (both multiple collectors and multiple layers of correlation and management—both local enclave and enterprise wide); and may extend to the cloud layer.

The invention may be provided with a cloud architecture to support multi-user data reporting and fusion (e.g. detecting threatening bot-nets), to supply download of configuration data for certain sensor functions (e.g. IP address-block characterization, signatures for malware string-matching sensors, known bot-net/malware site address lists), to supply “external information” data in real-time (trusted/sanitized inter-enterprise data) to facilitate faster detection of, and response to, attacks not specific to the enterprise, to download of “best practice” traffic rule sets/models/hypotheses or to support collections of useful sensors and ways to custom-configure and compile them in the cloud for subsequent download to user site.

The feature sets supported by the invention supports feature sets for Layer 2 thru 7 analyses and include algorithm considerations for various threat types.

Naive prior art anomaly detection algorithms have not been successful in IDSes because even normal traffic exhibits intermittent excursions from small envelopes of behavior classified as “normal.” The two anomalies that are most likely to appear in DoD networks are “flash crowds’, i.e., sudden high loads on a server or servers due to the recent appearance of frequently-downloaded information, and the “D-Day” phenomenon, where sudden changes in geopolitical situations or major operations drive abrupt changes in traffic patterns. Both phenomena may occur at full network scale or at enclave scale.

Algorithms must therefore look for traffic properties that are more invariant than just comparing traffic loads or host peering groups to statistical norms, or correlate behavior across many users to distinguish flash crowds and D-Day traffic shifts from floods of malicious traffic. The selected suite of algorithms of the invention avoids learning what is normal by explicit training sets (as is done in machine learning techniques), and instead relies on rules and models that, while adaptive, are based on reasoning about the system.

With respect to asymmetric flows, once away from leaf nodes of networks such as enterprise LANs, there is no guarantee that the traffic from host A to host B flows over the same links (in the reverse direction) as traffic from host B to host A, and in fact it frequently does not.

Consequently, the algorithms of the invention do not rely on seeing both directions of traffic for proper operation. In general, this means, the invention looks more carefully at the traffic and also looks at reverse traffic for other inferences. This is most crucial when determining if there is a successful connection attempt or not. For the most common case—TCP traffic—this can be inferred by watching ACKS, flags, windows, and sequence numbers in the TCP header since these react to control information on the reverse channel.

Down sampling is a scaling approach often used with Net Flow data, due to router performance limitations. Down sampling is an unacceptable approach as the sole way to scale algorithm performance—not only does it sometimes miss crucial flow starting and ending activities, but at higher data rates, it may miss entire flows, and it invites single-packet and low-and-slow attacks that are likely to be missed in the sampling process. Down sampling is a last-resort choice to deal with performance limitations in existing equipment, not a viable scaling approach in itself.

There are distinct technology barriers to algorithm performance at multi-gigabit data rates. Since network traffic processing is dominated by non-local memory references to large tables, memory performance limitations are far more important than mathematical and logical operations in assessing algorithm scalability. As packet durations shorten from 500 ns at 1 Gb/s to 5 ns at 100 Gb/s, there are four distinct concerns:

DRAM memory is limited to one random access per 50 ns; this becomes a major barrier to operating above 5 Gb/s. Reduced latency devices (20 ns) allow operation up to 10 Gb/s.

Today's SRAM memories handle random accesses at 2.7 ns or less (getting exponentially more expensive for higher speeds), allowing about 2 accesses per packet at 100 Gb/s, but they have bus turn-around performance losses for the common read-modify-write operation. QDR SRAMS, with separated read/write buses, are used at 100 Gb/s, also allowing a lower clock speed of 250 MHz (4 ns operation).

SRAM memory sizes are substantially smaller than DRAMS, with the largest current memory provided at 72 Mb vs. 2 Gb for DRAMS. This places a severe constraint on data table sizes, which may constrain effective algorithm design.

Processor core instruction clocks have hit a plateau at about 3 GHz, with higher performance processors depending now on multiple core parallelism. This permits only 15 (up to 45 for 3-issue) instructions per 5 ns 100 Gb/s packet. Network processing in typical CPUs takes 1000+ instructions/packet, mostly for operating system device driver overhead. The core operations of TCP processing require about 100 instructions/packet, as does basic packet forwarding code.

The algorithm deployment platform design choices of the invention are made expressly to avoid these concerns. Routers are constrained by the same issues, so some network parameters, such as the number of routable prefixes, will remain constrained to tractable values.

With only 5 ns per packet for processing (though pipeline parallelism can multiply this by a factor of 10 or so), algorithms that operate directly on packets are undesirable. Thus, the scalable algorithm design favors algorithms that do not operate at the packet timescale, but instead operate on aggregated data collected by very simple data collectors and analyzers that operate on a per-packet basis. Per-byte algorithms (such as regexp matching) are not feasible at the 100 Gb/s byte clock rates of 12.5 GHz, without employing massive load-splitting parallelism.

A subtle aspect of scalability is that algorithms and processing resources need to evolve over time, as adversaries adapt their attack strategies to evade existing network defenses. Thus, not only the algorithms must be scalable, so must the execution environment in which they run. The architecture of the invention supports modification and replacement of algorithms to meet constantly evolving threats.

Few, if any, detection algorithms have sufficient information to unequivocally classify events as malicious or benign. Just as law enforcement investigators rely on multiple witnesses and sources of information, and on known patterns of criminal and non-criminal behavior, the system combines sources of information and models of network and attacker goals and behavior to come to a clearer understanding of network events, and to correctly classify them.

A high-performance pipelined FPGA hardware design supports a wide variety of sensors that examine the traffic stream flowing past each sensor in the processing pipeline. In general, computation isn't a limiting factor; the most computationally intensive operation is hashing, which can be performed simultaneously on multiple fields and field combinations, using the hundreds of dedicated multiplier blocks in the FPGA. Thus the primary limitations on sensors are memory access time and memory table size. These constraints are discussed below for each of the general sensor types.

Counters are the most common type of network sensor in existing network devices: generally used to measure flow rates and network performance. However, counters can overflow rapidly at 100 Gb/s. For instance, a 32-bit data byte counter overflows in less than 350 ms, and a 32-bit packet count overflows in about 13 sec. Byte counters with a larger granularity (e.g., 16 or 64 bytes per increment) may be used, at minor loss in accuracy, or the counter size may be increased to 48 or 64 bits, at a cost in increased memory table size. At 100 Gb/s, each counter table requires a dedicated high-speed memory, with size limited to 4M 64-bit or SM 32-bit entries.

Bit flags are used to indicate a simple event has occurred, such as use of a particular port or communication with a particular host. Bit-flag sensors are desirable for use with large tables, due to memory size limits.

The packet capture buffer sensor of the invention collects packets identified as needing analysis by higher-level software, and forwards copies to the control CPU. This sensor must be monitored since it will be easy to overrun any practical amount of memory buffer at 100 Gb/s line rates—the control CPU's processing rate will be roughly 1000 times slower.

The payload histogram of the invention is a set of counters (typically 256) that counts occurrences of individual byte values in a particular data stream. The main use of this element is to detect encrypted (or highly-compressed) traffic. Operating payload histograms at 100 Gb/s requires employing parallel temporary counter memories for each byte lane until packet end, and analyzing and summarizing the results in a few bits, which is written to a flow- or host-indexed data structure.

The content of the hash table of the invention can be counters, flags, flow rate estimators, or bit-vectors. A limitation on hash tables is the table should not be more than 50% populated, that only one read and one write is allowed per packet, and that entries in external memories should be multiples of 64 bits (the transfer Width). Hash collisions may be mitigated by using internal FPGA memories for “spillover” tables, so that multiple accesses are not needed to external memories, and that the spillover accesses can happen in parallel.

Arrays are used for sensors with small index values, such as counters of IP protocol or port use. Small arrays (up to 64K entries) may be kept in internal memories; others may require dedicated external memories, and have the same performance limitations noted for hash tables.

Maps are used to translate one index or data value into a different value space. These are hash tables that map index values (e.g., host addresses or IP prefixes) to attribute flags or values. One example is a map of IP prefixes to a risk assessment of the address block as a peer, based on geographic or ownership information about the address block. Another is a map of host IP addresses to various known or inferred attributes about the host, such as seeing it transmit or receive on port 80, suggesting it is a Web server.

A Bloom filter element is used as an efficient data storage structure that uses multiple independent hash values to set (or query) single bits in a large hash table. It is used to compactly store a single Boolean value for a very large value space. The Bloom filter is useful as a pre-filter to determine, for example, which flows should receive additional analysis or packet capture for higher-level software.

A hash spectrum is used as a histogram driven by a hashed index value. A content replication detector uses a variant large-memory hash spectrum detector based on a spectral Bloom filter. This sensor may be configured to prevent the histogram bins from overflowing, by allowing the sensor to run continuously, with a slowly decaying memory of prior traffic.

A compact flow rate sensor acting as an approximate flow rate sensor is provided to minimize the amount of memory required per flow, since flow tables are likely to be one of the largest data structures required. In many cases (e.g., detection of exfiltration), knowledge of the actual flow rate is unnecessary-all that is required is a rough categorization of the flow rate and direction to determine whether it is suspect. This sensor preferably adapts the classic “clock” algorithm used in demand paging systems in modern operating systems.

A pattern matcher is provided to complete the requirements there may be a need for pattern matching, the pattern matcher should scale to 1M; 64-bit patterns at 100 Gb/s.

The following generally describes six exemplar algorithms used to implement the architecture of the invention are used to address the major forms of attack: malicious behavior, malicious code infections, information gathering, and covert control of assets.

Traffic behavior analysis is an emergent property that requires operating on periodic snapshots of aggregated data about packets and flows rather than examining single packets as they arrive. The traffic behavior analyzer of the invention uses multiple tables produced by the hardware data collectors, and generates events based on a set of heuristic rules. These events indicate unusual behavior due to misconfiguration, policy violations, or malicious behavior. The algorithm is a good example of direct use of several tables and maps generated by the data extraction sensors in the high-speed hardware. One set of data structures holds host-based information, one set focuses on the addressing structure, and a third set keeps flow-based data.

A host index table maps host indexes used in other tables to actual IP address. A host attributes table collects various flags about a given host address. The table is configured to record the use of well-known ports, port classes, and protocols. It also may include any information known through configuration or other data collection. The host traffic table collects approximate data rates and packet sizes for all traffic to or from the host. A host peering density table is a small hash map with a bit set for each peer host that has communicated with a particular host in the last data collection interval. This is used to estimate the number of peers the host communicates with.

An address block index table maps address block (prefix) indexes to IP prefixes; this is not collected but generated from IP address block assignment information. The address block attributes table is a table derived from public data sources and some configuration. It indicates whether the address block is within the protected network boundary or outside it, whether the address block is “dark” (either non-routable or has no connected hosts), whether the block is primarily dynamic addresses (e.g., a block owned by an access ISP), and contains assessment of the risks associated with communications to addresses within this block (e.g. distinguishing U.S. corporate networks from address blocks owned by hostile foreign governments). IP geo-location service databases may also be used to identify blocks associated with areas of special risk. The address block traffic table is similar to the host traffic table, but indexed by address block, rather than full address. The address block peering table is similar to the host peering density table, but indicates which address blocks have communicated with each other.

A flow index table maps flow index to source and destination host indexes, protocol, and port numbers (if present). The flow traffic table contains both flow rate information (similar to the Host Traffic Table) and flags (for TCP connections) indicating specific TCP flags have been seen.

Note that at low data rates, all these tables may constructed by processing NetFlow data, however, at 100 Gb/s, the rate of flow creation (and completion) will be on the order of 100K per second. Processing NetFlow data at that rate is not scalable due to the lack of locality in memory references from flow to flow.

The traffic behavior analyzer periodically receives updated copies of the tables from the hardware data collection system (via DMA and a device driver). The main table entries are then sequentially scanned using a number of rules for normal and abnormal traffic and host behaviors. These rules retrieve related information from other tables, as well as from previous copies of the tables kept by the analyzer.

There are many possible rules for detecting malicious behavior, just as there are typically many packet-pattern rules in conventional intrusion detection systems. However, these rules apply to the aggregated data, and not to individual packets, thus greatly reducing the processing rate required. The tables are processed on the order of every 10 seconds, and to contain approximately 1M entries each for 100 Gb/s operation. Thus the average entry can be received in one ms of CPU time—about 30K instructions in a single 3 GHZ CPU.

Examples of rules coded as event detectors in the invention, include, by way of example and not by limitation, rules that detect:
1. A host with previous history as a client machine that begins accepting or sending traffic on a server port (e.g., starts acting as an HTTP server),
2. A server that is initiating client-like connections,
3. A client machine (one that has a small number of peers known to be servers) beginning to send or receive traffic with a much larger number of peers,
4. A machine that is sending more traffic than it is receiving, is not a known server, and is communicating with hosts in a suspect communicating with hosts in a suspect address bloc,
5. A machine that is behaving like a server (has ‘many peers and is sending large amounts of traffic), but is not using any well-known port,
6. A host that is setting up connections to host(s) in address blocks known to be primarily dynamically allocated (i.e., is unlikely to contain legitimate servers),
7. A machine that sends to an un-routable or “dark” address block.

The invention is configured so that each rule produces an associated event when it triggers, which will contain all information used in the rule (e.g., host, address block, and/or flow index values, along with the full address, port, and protocol information that corresponds to the indexes.

Behavior-based detectors generally rely on two things: 1) accurate descriptions of bad (or good) behavior, and, 2) the attack exhibiting that behavior. Given an attack, it is possible to construct rules to detect the attack's behavior with near 100% probability of detection.

A threat class that is often overlooked is client-side exploits. Client-side exploits take advantage of vulnerabilities in client software. Where “classical” attacks focus on web, mail, database, and other services offered by servers on a network, client-side exploits focus on client applications such as web browsers, word processing applications, and image viewers.

Client-side exploits are particularly problematic because they are not normally prevented by perimeter defenses. It is the client that is permitted to make a connection to an external server. The external server may now opportunistically provide malicious content to systems that visit it based upon any number of criteria including (but not limited to) OS version of the client, IP address range of the client, or the type of content the client is interested in retrieving.

An example client side exploit is a user visiting a malicious web site or a legitimate website that is serving malicious content, where the exploit is in a graphics image is retrieved from the main page: the content of the image is malformed in such a way as to intentionally induce a buffer overflow in the client browser application. An algorithm is provided for identifying client-side exploit activity that constructs correlations between clients and their actions involving external systems after an initial internal-to-external session. This is a behavior-based algorithm that relies on the attacker taking certain actions to accomplish his goal; if these actions aren't taken, the attack isn't conducted. Therefore, as in traffic behavior analysis, one can construct rules from such features as the duration of sessions, relation to prior sessions, content, and statistical deviation from expected content models to determine with near 100% accuracy whether such follow on activity results from a successful client-side exploit.

Most of the data required for analysis can be extracted from the tables collected for the traffic behavior analysis algorithm, namely the host attributes table (client identification), the host peering density table (novel peer connections), and the flow traffic table (specific connections by the host), with possible contributions from the address block attributes table (suspect peer addresses).

Content analysis requires use of a payload histogram sensor with added high-speed processing to classify the content type and note it in the flow record, or a more specialized sensor. Consequently, the same scaling argument used for traffic behavior analysis can be applied.

The basis of the network monitoring system is a suite of sensors and algorithms that examines network traffic for certain behaviors that are indicative of malicious activity. This section presents categories of malicious activity, and lists for each category the algorithms of the invention that contribute to detecting behaviors indicating that activity:

Reconnaissance

The host is running port scans or similar activities on a large number of internal or external hosts.
Host Peering

ICMP messages are often elicited by scanners looking for open server ports, and ICMP Echo “pings” are used to detect active addresses. ICMP replies to external hosts may be the only signs of scanning when asymmetric routing is present.
ICMP Monitor
DNS Monitor

Reconnaissance may be detected to some degree due to use of illegal addresses, or novel addresses or external address blocks.
Header Analysis

Any type of scanning activity can be detected, although extremely low and slow scans may not rise beyond what is set for a reporting threshold.
Entropy

Client hosts receiving (but not sending) traffic on well-known server ports; inbound scanning.
Host Characterization

Compromised client hosts sending outbound to many non-dynamic ports in a short period; outbound scanning
Host Characterization

Hosts initiating too many “not live” sessions, scanning and probing the network
Flow Analysis
Host Characterization

Exemplar Attacks
Scans from one host to many internal hosts
Scans triggering ICMP replies
Scans to illegal addresses
Client hosts receiving but not sending on well-known ports
Outbound scanning from one internal host to many non-dynamic ports

Compromise

Connections appear reversed from expected because traffic flow rates don't correspond to port directions.
Host Characterization
Flow Analysis

Outbound TCP connections from well-known ports that normally only receive inbound connections.
Header Analysis

Suspected compromised client host since known client is sending on well-known server ports.
Host Characterization
Flow Analysis

Suspected compromised server since server is sending to well-known ports (i.e. acting as a client).
Host Characterization
Flow Analysis

A large peering increase, with a variable set of peers, may indicate the host has been compromised and is being used as a malware server (e.g. for spam generation or as a download host for second-stage infection).
Host Peering

Widespread distribution of a phishing spam within the protected area is detected.

Non-SMTP server sending to outside SMTP ports, suggesting spam is being distributed.
Host Characterization

Hosts with low-rate flows with small packets that tend to come in clumps with widely spaced intervals (more than 0.5 sec) on average between clumps (indicating interactive sessions where perhaps they shouldn't be) [not currently considered a strong indicator]
Flow Analyzer

Example Attacks
A client host is compromised and begins to serve content (on well-known ports)
A server acting as a client

Exfiltration

High outbound aggregate flow rates from a host not known to be an outward-facing server.
Host Characterization

Using ICMP messages to carry data through firewalls.
ICMP Monitor

Exfiltration may be detected due to use of illegal addresses, or novel addresses or external address blocks.
Header Analysis

Using false DNS messages as a channel for exfiltration to avoid firewall barriers.
DNS Monitor

Example Attacks
Trojan horse/compromise collects and exfiltrates large data files.
Backdoor
ICMP tunnel

Botnets

A large increase in peering, with a relatively stable set of peers may indicate a botnet control or relay node. A persistent peering relation with an external address block not known to contain popular servers or services may also indicate a botnet slave.
Host Peering

Any activity that involves a host contacting multiple destinations (or a large number of ports) in a short amount of time can be detected.
Entropy

Persistent use of unusual ports for C2 connections
Host Characterization

Botnet outbreaks may all be detected to some degree by the Header Analysis algorithm, primarily due to use of illegal addresses, or novel addresses or external address blocks.
Header Analysis

When the botnet uses ICMP as a covert C2 channel
ICMP Monitor

Malware Propagation

A large increase in the number of peers, especially “pinning” the sensor to its maximum value, suggests the host is attempting to spread a fast-propagating virus or worm.
Host Peering

Any activity that involves a host contacting multiple destinations (or a large number of ports) in a short amount of time can be detected.
Entropy

Outbreaks may all be detected to some degree by the Header Analysis algorithm, primarily due to use of illegal addresses, or novel addresses or external address blocks.
Header Analysis

Propagation of most worms and network-delivered viruses is detected, though polymorphic ones are difficult to detect.

Software updates may be benign (OS or application software update) or associated with the spread of a virus/worm (download of the full attack package) or botnet (new bot software distribution).

Known malware/signature can be detected by preloading the filter with blacklisting values derived from known malware signature strings.

Evasion

Source spoofing, where the source address doesn't match direction on link (inbound protected address, or outbound packet with external source address.
Header Analysis

Firewall evasion, such as misuse of well-known port numbers usually passed by firewalls.
Header Analysis

IDS evasion by use of TTL or checksum values to trick IDSes into ignoring packets that are incorrectly processed by hosts.
Header Analysis

Firewall and IDS evasion by employing ICMP messages to carry attacker communications that easily penetrates firewalls and is often overlooked by IDSes. ICMP Echo/Echo Reply and ICMP Timestamp/Timestamp Reply are the most easily employed message types for this, but other types might be employed as well.
ICMP Monitor

Using false DNS messages as a channel for C2 of compromised internal hosts, to evade firewall barriers.
DNS Monitor

Denial of Service

Using ICMP messages to mis-inform host protocol stacks to shut down or misdirect traffic. This can include use of ICMP Redirect to “blackhole” traffic or direct many LAN hosts to send their traffic to a target host to overload it. Various ICMP Destination Unreachable subtypes might cause hosts to break off existing connections, and code 4 (Fragmentation Needed and Don't Fragment Set) could be used to greatly throttle traffic by reducing MTU values. Large numbers of ICMP Echo messages or inbound ICMP Time Exceeded messages may indicate DoS attacks on the IP control plane in routers or hosts, since these are often processed by special mechanisms in routers and host operating systems.
ICMP Monitor

Outbreaks may all be detected to some degree by the Header Analysis algorithm, primarily due to use of illegal addresses, or novel addresses or external address blocks.
Header Analysis

Traffic redirected by misuse of ICMP Redirect messages.
ICMP Monitor

DNS poisoning: Feeding false information to the local DNS server to redirect traffic to malicious servers.
DNS Monitor

Large number of connections to hosts will appear to be invalid connections and as long running flows.
Flow Analyzer

Attacks on Hosts

Based on host mis-processing of ICMP messages, including undefined or generally-unused message types, or inconsistencies between the ICMP message IP header and the included IP header in the message body. An incoming ICMP Parameter Problem message may indicate that a local host is sending malformed packets; this may be the only indication of such packets if asymmetric routing is present.
ICMP Monitor

Attacks based on use of various uncommon features in packets, out-of-bounds values in fields, or fields of invalid size.
Header Analysis

Oddities with the TCP flags
Flow Analysis

Suspect Address Regions

Suspect external domains, either domain name features commonly seen correlated with malicious domains, or fast-fluxing: short DNS TTLs for domains hosted on dynamic DNS, typically malware servers, C2 relays, or exfiltration data drops.
DNS Monitor

Suspect external address use with IP addresses that haven't been seen in recent DNS responses, suggesting direct numeric IP address URLs or application-embedded IP addresses, both commonly associated with malicious traffic.
DNS Monitor

DNS Attacks

Direct attacks on DNS servers, such as by a DNS-based exploit
DNS Monitor

DNS misuse, where a non-DNS server is sending to an external DNS port or an external DNS is sending to a server other than local DNS server. (Outbound could be a DNS attack on outside host, exfiltration, or evasion of monitoring at local DNS server; inbound could be DNS poisoning attack on host, DNS-based exploit, or local DNS bypass attempt to avoid monitoring at local DNS server.)

A novel anti-virus intrusion detection system is a system for detecting rapidly replicated data segments within network traffic such as would be produced by a spreading worm or virus. The algorithm uses an efficient data structure to count the number of occurrences of blocks of network packet data as they pass by an observation point.

Alarms are tripped if the counters increment too fast; otherwise, the counters steadily decrement over time to prevent the counters from overflowing. Experimentation with a large amount of email traffic shows that the system quickly reaches a steady state, and counters representing rapidly replicated data blocks trip alarms within 64 occurrences of the data block.

The anti-virus intrusion detection system algorithm is provided to discover any blocks that are occurring in a traffic stream with a frequency exceeding a certain threshold, thus detecting those data blocks that are part of a rapidly replicating virus or worm. However, there are many blocks that are completely benign. To handle this, the algorithm allows for a priori white listing certain blocks. This effectively turns the algorithm off for these blocks. Such white listed blocks would include long strings of a single ASCII value such as NULL, SPACE, or other values that may pad out packets in, say, bulk data transfers. It is expected that certain benign blocks will also be discovered during the run of the algorithm, so a mechanism is provided to Whitelist these blocks.

Likewise, there is a set of blocks that are known to be part of a virus or worm, and there is no need for letting the algorithm(s) discover them anew each time it is started. Consequently, there is a provision for blacklisting these had blocks. This effectively causes any block that matches the black list to raise an alarm immediately.

The anti-virus intrusion detection system algorithm breaks the payload from all packets into data blocks, and counts them in a hash spectrum. Loading the blocks into the hash spectrum is the hardest part for scaling the algorithm to 100 Gb/s. This has been done at 10 Gb/s in the anti-virus intrusion detection system project and expect the design for the ultra-high-speed hardware handle the load at 100 Gb/s. When an element in the spectrum (representing the number of occurrences of a particular block) trips a threshold, the anti-virus intrusion detection system algorithm produces an event indicating that the data block may be part of a malicious infection within the network.

The anti-virus intrusion detection system catches every virus attack that replicates above a tunable rate. It also catches replicated data that is not an attack, so a combination of white listing and alert reinforcement through the event correlation analyzer, will reduce the false alarms.

In the course of normal activity, any standard user will access a limited number of destinations (hosts) and services (ports) in any network. Repeated connections to the same small set of machines are expected. In contrast, in order to actively gain coherent information about a network, an attacker must systematically probe the target infrastructure. Repeating any particular connection does not serve to increase the attacker's knowledge and thus is not useful. Using information theoretic measurements, we can distinguish between these two different types of behavior. The system uses these measurements on some fundamental quantities including conditional probability and entropy measurements.

These qualitative differences between the conditional probabilities associated with a typical user and with an attacker conducting a scan can be quantified using entropy calculations. Entropy is a measure of uncertainty in a probability distribution. The probability of detection is directly related to how hard the attacker works at acting normally. This entropy algorithm detects all information gathering attacks that shows stronger entropy than is expected. It identifies benign activity that exhibits strong entropy and relies on the event correlation analyzer to reduce the probability of these false alarms.

The invention also works by examining traffic at one or more locations within a network. Recent traffic content that shows an unusually high degree of replication—that is, has data portions that occur in many packets within a brief amount of time—is deemed suspicious and an alert is issued. The approach is targeted at high rate events, and has limited ability to deal with malcode that is polymorphic, encrypted, or has otherwise been transformed in a way that does not preserve the native replicated patterns. The response (either manual or automated) to an alert involve the analysis of the suspicious data and if needed, removing the data from affected systems and networks.

Responses may include, but are not limited to:

1. Sending notifications to a human operator or an automated analysis and response system,

2. Selectively discarding suspicious packets,

3. Working in conjunction with a trace-back system (if installed in the network) to determine where the offending packet entered the network.

Normal for network traffic to contain certain replicated patterns that are benign. The invention therefore provides an interface to load known good data patterns in order to avoid unnecessary alerts. This loading and accounting for known good patterns is called “whitelisting”. A related point concerns known bad patterns for which a notification strategy that is different from the default may need to be configured. This loading and accounting for known bad patterns is called “blacklisting”. The approach, therefore, provides an interface to load known bad patterns and to configure the related notification strategies.

A brief summary of the algorithms underlying the approach is provided. The algorithms sit on top of a packet capture facility. Observed packets are broken into fixed size chunks (partial chunks are padded) and hashed using a spectral Bloom filter. The counter whose index matches the hash value of the chunk is incremented (unless whitelisted), and when the count exceeds a configured threshold, an alert is issued. In order to purge ancient history and track the current/recent state of the network, it implements a special decrementer algorithm. The decrementer cycles through the counters and decrements their values by one (unless the counter matches a blacklisted pattern) with the objective of keeping the sum of all counters at a certain threshold.

A provided phishing detection algorithm is a proactive detector for stemming phishing attacks. It uses the arrival of spam messages into distributed monitors (spam traps) as input to an early warning system for detecting and mitigating phishing attacks. The algorithm proceeds as follows:

1. A widespread deployment of spam traps collects spam messages. Each sensor runs regular-expression analysis and extracts (1) messages that are likely to correspond to phishing attacks and (2) the specific URLs being phished.

2. The sensor extracts the SMTP relay of the sender to identify a member of a spamming botnet.

3. The sensor follows the suspect URL, possibly through a series of redirects, to extract the IP address that is hosting the phishing site.

4. The sensor passes the IP address of the phishing site to a network management system that can detect when client hosts on that network fall victim to a phishing attack.

5. Depending on how the management system deployed, detection can be coupled with preventive measures. For example, the system could be incorporated into the DNS resolver and quarantine could be based on DNS-based “garden-walling”. Alternatively, it could be incorporated into the IP substrate: phishing attacks could be incorporated in route or packet filters, by filtering traffic to or from IP addresses that are hosts for likely phishing sites.

Step 1 is the only place where there is any uncertainty in the probability of detection.

With respect to botnet detection, for any bot to be part of a botnet, they have to communicate with a command center and/or with each other relatively frequently to get updates and coordinate their activities. Further, such communication activities from bots of the same botnet are driven by the same botcode. Thus, one can often observe that network activities of bots within the same botnet are correlated with each other and even with their own previous behavior.

The invention is a network anomaly detection system, BotSniffer, that can capture the spatial-temporal and correlation properties of botnet command and control (C2) activities in an enterprise network.

The key observation is that bots have much stronger synchronization in sending messages than do normal users. BotSniffer identifies the similar messages sent within the same time window from hosts in the monitored network. After observing several rounds of such (group) message transmission, BotSniffer computes and aggregates the degree of synchronization or homogeneity from each round of messages to identify whether these hosts are bots of the same botnet. BotSniffer utilizes a Threshold Random Walk (TRW) algorithm to calculate a comprehensive anomaly score from the rounds of observations. TRW is a powerful statistics tool that can converge to a decision within a small number of rounds of observation and with a pre-specified false positive and false negative rate.

The advantages of the algorithms include: (1) no prior knowledge of C2 servers or content signatures is required, (2) encrypted C2 traffic does not evade the system, (3) the system does not require a large bot presence in the monitored network, and (4) the system has a specifiable false positive and false negative rate.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

We claim:

1. A method for analyzing network, transport and application protocols in a computer network to identify a predetermined network behavior comprising the steps of:
monitoring and logging a port usage in a first host in a computer network,
monitoring and logging a set of first host information,
monitoring and logging a set of data activities in the network for a predetermined change in the first host information and in a first host data flow, and,
generating an alert to a user based on a correlation between the logged port usage, the logged first host information and the logged first host data flow.

2. The method of claim 1 wherein the first host information is selected from at least one member of the group of information consisting of an IP address used by the first host, an operating system used by the first host, a service being provided by the first host, an IP protocol used by the first host, a TCP port used by the first host, a UDP port used by the first host, connected host information with which the first host communicates, services used by the first host, a TCP port contacted by the first host, and a UDP port contacted by the first host.

3. The method of claim 1 wherein the data logged consists of data selected from at least one of the group consisting of a timestamp, an event or alert type, a rating, a network layer protocol, a transport layer protocol, an application layer protocol, a source IP address, a destination IP address, a source and destination TCP and UDP port, an ICMP type and code, a packet header field, a predetermined policy violation, a use of a predetermined application service, an IP time-to-live, a number of bytes and packets sent by a source host and a destination host for a connection, a prevention action performed, a connection or session ID, a decoded payload data, an application request and response, and a state-related information set.

4. A device for analyzing network, transport and application protocols in a computer network to identify a predetermined activity comprising:
a sensor platform comprising at least one sensor configured to collect and export a predetermined data structure from within the firewall of the network comprising aggregated data about a network host, flow and address block, and comprising a sensor control processor,
a correlator server configured to support at least one sensor control processor,
an optical I/O module,
an SRAM processing module, and,
a DRAM processing module.

5. The device of claim 4 wherein at least one of the I/O modules, SRAM modules or DRAM modules is comprised of a combined memory array and field programmable gate array device comprising a field programmable gate array (FPGA),
an access lead network electrically coupled and proximate to the FPGA,
a plurality of external memories electrically coupled and proximate to the access lead network, and,
wherein the FPGA can independently access each of the plurality of external memories via the access lead network without use of an address/data bus.

6. The device of claim 4 wherein the SRAM module comprises a plurality of interconnect ports and a plurality of independent SRAM memories and the DRAM module comprises a plurality of interconnect ports, at least one independent DRAM memory, and at least one SRAM memory.

7. The device of claim 4 further comprising a hash spectrum detector and a spectral Bloom filter.

8. The device of claim 4 further comprising a TCP flow rectifier configured to re-order and align a TCP flow content into a predetermined format.

9. The device of claim 8 where the predetermined format comprises TCP payload information and a header that identifies a data flow.

10. The device of claim 8 wherein the TCP flow rectifier module is configured for input header processing/flow ID extraction processing, TCP flow state and gap record management processing, buffer bypass TCP payload packet processing, DRAM buffer processing, buffer playout manager processing and output header generation processing.

11. The device of 8 wherein the TCP flow rectifier is configured to output TCP payload streams in interleaved blocks for multiple flows simultaneously.

12. The device of claim 8 wherein the TCP flow rectifier is comprised of a DRAM-based buffer memory configured for storing payload segments, and an SRAM-based flow state memory for storing a TCP flow state and a TCP gap records.
